(19) United States
(12) Patent Application Publication
(10) Pub. No.: US 2023/0030247 A1
(43) Pub. Date: Feb. 2, 2023

(54) METHOD OF ASYNCHRONOUS REPROJECTION OF AN IMAGE OF A 3D SCENE

(71) Applicant: ALT LLC, Moscow (RU)

(72) Inventor: PETR VYACHESLAVOVICH SEVOSTIANOV, Voronezh (RU)

(21) Appl. No.: 17/388,404

(22) Filed: Jul. 29, 2021

(51) Int. Cl. H04N 13/122; H04N 13/117; H04N 13/128; G06T 19/00; G06T 19/20

(52) U.S. Cl. CPC H04N 13/122; H04N 13/117; H04N 13/128; G06T 19/003; G06T 19/006; G06T 19/20; G06T 2219/2016

(57) ABSTRACT

Invention relates to processing images of 3D scenes and to a method of asynchronous reprojection in a system of virtual or augmented reality, including (1) receiving color data and depth data of an initial 3D scene image for view A; (2) determining visual features of the initial 3D scene image and weights of the visual features, based on the color data, and determining depth of the visual features of the 3D scene image, based on the depth data; (3) generating a low polygonal grid for reprojection; (4) performing reprojection of the initial 3D scene image for view B different from view A by displacement of low polygonal grid nodes depending on the weights and depths of the image visual features. The method assures a high 3D scene frame rate, reduces image distortions at item borders during reprojection, and decreases data volume for 3D scene image transmitted via a communication channel.

### FIELD OF THE INVENTION

The invention relates to processing images of 3D scenes, in particular, to a method of providing asynchronous reprojection in a system of virtual or augmented reality.

### CONVENTIONAL ART

Virtual or augmented reality (VR/AR) systems for entertainment, information, education, scientific, industrial, etc. purposes apply quite rigid requirements regarding quality of image and rate of generation and output thereof to a display. These systems have to not only respond to any motion of a player almost instantly (like a head turn or a hand wave), but also provide a persistently high frame output rate. Although it is usually sufficient to assure a frame output rate of 30 fps (frames per second) in conventional (non-VR/AR) computer games and 60 fps rate is considered excellent performance, modern VR/AR devices require 90 fps rate as a minimal accepted value.

In has to be noted that the frame output rate needs to be persistent and should not vary during the entire game to provide user's comfort. In a usual game using a computer display or a TV set, it is most probable that a drop of the frame output rate down to, e.g., 30 fps would remain unnoticed by a majority of users, but even a short decrease in the frame output rate in VR/AR systems may destroy the immersion effect due to image bounce and delay from user's movements, which can cause discomfort and sometimes VR-sickness [1].

Modern head-mounted displays (HMDs) like OCULUS RIFT or HTC VIVE support special technologies (generally referred to as reprojection technologies) intended to smooth rendering rate drop for 3D scenes caused by an increase in complexity of generated image. These technologies provide intentionally increase in rate of outputting frames to display in order to improve user experience, decrease requirements to computer hardware and provide additional opportunities to developers of applications for such systems.

There is a known method of reprojection named Interleaved Reprojection in SteamVR or Synchronous Timewarp in OCULUS SDK [1], where if the system is not able to assure rendering rate of 90 fps, the rate is decreased to 45 fps and the system generates intermediate frames using previous frame as a base and rotating it by 2D transformation by an angle of user's head pivot performed during this time. Therefore, the frame output rate remains 90 fps. The main disadvantages of this method are (i) its ability to respond to user's head pivot only, but not to user's head displacement and (ii) step-wise (namely, twofold) decrease in rendering rate even when the system is short of just 5% or 10% of performance of the 3D engine. Moreover, a user is able to notice a perceptible jerk of image at the time moment when reprojection is on and off.

There is also a known method of reprojection named Asynchronous Reprojection in SteamVR or Asynchronous Timewarp (ATW) in OCULUS SDK [2], [3], wherein the system generates intermediate frames using previous frame as a base and rotating it by 2D transformation by an angle of user's head pivot performed during this time, similar to what is done in Interleaved Reprojection or Synchronous Timewarp, but this process is implemented in a separate flow that does not depend on the 3D engine. If the 3D engine outputs a generated frame at an appropriate time point necessary for maintaining a required output rate (90 fps), then this frame is outputted to the display; if the 3D engine is not able to perform rendering in time, then a result of reprojection of the previously rendered frame is outputted to the display. This allows avoiding an intentional limitation of rendering rate for the 3D engine so as to let it generate frames at a rate it is currently able to maintain and thus reduce the number of “artificial” frames. However, the main disadvantage of this method is its ability of responding to user's head pivot only, but not to spatial displacement thereof.

In addition, there is a known method of reprojection named Asynchronous Spacewarp (ASW) in OCULUS SDK [4], [5], wherein the system generates intermediate frames taking into account spatial displacements of user's head, game controllers, camera and game characters. To do that, a depth map data of the most recent frame generated by the 3D engine is used, based on which the ASW algorithm derives information on spatial relationships between locations of different image elements. This approach allows not only shifting a point of view according to the user movement, but also simulating displacement of some items relative to the others in the intermediate frame. However, since only the most recent frame depth map is used in the ASW, rather than a full 3D model, the algorithm does not have information on distant elements of the 3D scene positioned behind proximate items, therefore image defects (artifacts) in areas exposed to the user upon movement of the items inevitably emerge when intermediate frames are generated. Moreover, the ASW algorithm causes problems related to processing semi-transparent surfaces and to application of anti-aliasing technologies.

Patent documents US2015002542A1, US20150029218A1, US20160343172A1, US2016335806A1, US2017345217A1 describe a method of increasing frame rate by asynchronous spatial reprojection when displaying 3D scene using vertical and/or horizontal shift of particular pixels or groups of pixels, depending on change in the viewer's head position. No approach for calculation of such a shift is disclosed.

Patent documents WO2017210111A1, US2017345220A1 describe a method of increasing frame rate by asynchronous spatial reprojection when displaying a 3D scene, including downsampling of the depth map and shifting polygon vertices of the initial image, depending on depth of these vertices.

Patent documents US20120206452A1, U.S. Pat. No. 9,122,053B2 describe a method of augmenting an image of real world with an image of a virtual item in an augmented reality system. Position of the virtual item on a display is determined, taking into account position of the virtual item borders in the real world depth map.

Patent documents U.S. Pat. No. 9,240,069B1, WO2017003769A1 describe a method of reducing a response delay by asynchronous spatial reprojection when viewer moves during displaying a 3D scene, the method including populating “empty” areas caused by reprojection, using different techniques like uniform painting, blurring, etc.

Patent documents EP3051525A1, U.S. Pat. No. 9,904,056B2 describe a method of increasing frame rate by asynchronous spatial reprojection when displaying a 3D scene, including separate generation of background of the 3D scene and foreground of the 3D scene in a main frame and generation of intermediate frames, where the 3D scene background undergoes reprojection depending on change in the viewer's head position, and the 3D scene foreground of the main frame is superimposed on the reprojected background.

Patent documents US20170155885A1, U.S. Pat. No. 9,832,451B2 describe a method of reducing video flow rate by asynchronous spatial reprojection when displaying 3D scene, where an original left frame is generated initially and a right frame is formed by reprojection of the left frame; afterwards, an original right frame is generated initially and a left frame is formed by reprojection of the right frame. “Empty” areas caused by reprojection are populated using “historical” information of corresponding former frames. No implementations of this populating operation are disclosed.

Patent documents US20170213388A1, U.S. Pat. No. 9,978,180B2, WO2017131977A1 describe a method of increasing frame rate by asynchronous spatial reprojection when displaying a 3D scene, depending on change in the viewer's head position, the method including homographic (e.g., affine) transformation and shift of pixels. No implementations of calculation of this shift are disclosed.

Patent documents U.S. Pat. No. 9,858,637B1, WO2018022250A1 describe a method of decreasing delay of displaying a 3D scene by asynchronous spatial reprojection, depending on change in the viewer's head position, on motion speed and acceleration. No implementations of the reprojection are disclosed.

Patent documents US2017018121A1, U.S. Ser. No. 10/089,790B2 describe a method of reducing response delay by asynchronous spatial reprojection when viewer moves during displaying 3D scene, the method including populating “empty” areas caused by reprojection using different techniques like uniform painting, blurring, etc.

Patent documents US2017004648A1, US2017200304A1, U.S. Pat. No. 9,607,428B2, U.S. Ser. No. 10/083,538B2 describe a method of reducing response delay by asynchronous spatial reprojection when viewer moves during displaying a 3D scene, the method including populating “empty” areas caused by reprojection using different techniques, such as uniform painting, blurring, etc., implemented with a variable grid size.

Patent documents US2017243324A1, WO2017147178A1 mention synchronous and asynchronous spatial and angle reprojection of a 3D scene image. No any approaches to implementation of the reprojection are disclosed.

Patent documents US2017374341A1, U.S. Ser. No. 10/129,523B2, WO2017222838A1 describe a method of spatial reprojection of a 3D scene image, including populating “empty” areas taking into account a depth map that may be coarsened to enable faster algorithm.

Patent documents US2017374343A1, U.S. Ser. No. 10/114,454B2 also describe a method of spatial reprojection of 3D scene image, including populating “empty” areas, taking into account a depth map that may be coarsened to enable a faster algorithm.

Patent documents US2018165878A1, U.S. Ser. No. 10/043,318B2, WO2018106898A1 describe a method of spatial reprojection of a 3D scene image with use of interpolation, which algorithm is not disclosed.

Patent documents US2018061121A1, WO2018039586A1 mention synchronous and asynchronous spatial and angle reprojection of a 3D scene image. No implementations of the reprojection are disclosed.

Patent document WO2018064287A1 describe a method of reducing response delay by asynchronous spatial reprojection when a viewer moves during a display of a 3D scene, the method including populating “empty” areas caused by reprojection using different techniques, such as uniform painting, blurring, etc.

Patent documents US2018275748A1, WO2018183026A1 describe a method of reducing delay of response to viewer's movement by reprojection, wherein the scene is divided into depth levels and shift is performed separately for different levels.

Patent documents US2018322688A1, WO2018204092A1 describe a method of reprojection for reducing delay of response to viewer's movement during displaying a 3D scene, using non-linear transformation of image. No implementations of such a transformation are disclosed.

Quality of the reprojected image in these known solutions is not acceptable when ASW method is used in six degrees of freedom (6DoF) VR/AR systems due to a presence of artifacts. In particular, visibility of the reprojected image distortions needs to be substantially decreased, which distortions emerge at item borders when ASW method is used.

### SUMMARY OF THE INVENTION

The invention relates to a method of combined asynchronous ATW/ASW reprojection in rendering systems having six degrees of viewer's motion freedom, which is further referred to as 6ATSW for short. The reprojection method of the invention implies detection of visual features of a 3D scene image, determination of their weight and depth values, formation of a low polygonal grid superimposed on the 3D scene image, and further selective deformation of the 3D scene image (i.e., the reprojection itself) by displacing nodes of the low polygonal grid depending on the weight and depth values of the image visual features.

The invention allows decreasing image distortions near borders of items during reprojection, owing to optimization of direction and amount of displacement of the low polygonal grid nodes, taking into account directions of the visual features of the 3D scene image, weight values and depth thereof in the 3D scene.

In addition, the invention allows assuring a required frame rate of 3D scene image on a display, owing to reprojection with a high quality of the image, so negative user experience like headache, vertigo, nausea and other manifestations of so-called “VR sickness” may be avoided.

Moreover, the invention allows reducing a volume of 3D scene image data per unit time, when transmitted over a communication channel, with no substantial increasing distortions of the reprojected image.

The invention implements an exemplary method of processing 3D scene image including the following steps:

(1) receiving color data and depth data of an initial 3D scene image for view A;

(2) determining visual features of the 3D scene image and weights thereof based on the color data and determining depths of the visual features of the 3D scene image, based on the depth data;

(3) generating a low polygonal grid for reprojection;

(4) performing reprojection of the 3D scene image for view B different from view A by displacement of the low polygonal grid nodes depending on the weights and depths of the image visual features.

The color data and the depth data may be represented in any suitable form, e.g., in form of frames of composite multi-layer images, where color data may be contained in one layer and the depth data may be contained in another layer of the image. However, representation of the data in the frame-like form is not necessary. In particular, the data may be represented in form of arbitrary bodies of data having corresponding dimensions or even may be distributed (i.e., the data does not have to be aggregated in a particular place prior to receiving it for processing). A source of the data may be a 3D engine, a 3D camera (e.g., like INTEL RealSense), a computer memory device, a Blue Ray disk or any other device for generating or storing a sequence of 3D scene images.

It should be noted that the bodies of data are represented by two-dimension arrays and referred to as “frames” and “maps” in the invention implementation examples described herein. However, it shall be understood that the terms “frames” and “maps” do not limit the invention and they are used merely as an illustrative example intended to facilitate understanding the invention.

Visual features of the 3D scene image are specific characteristics of the image, which affect reprojection results. In particular, such features are physical borders of items in the 3D scene, contrast (by color or brightness) edges of the image areas (e.g., like in “zebra” or “check pattern” images) and gradients (e.g., like a clear sunset sky gradient). Each visual feature is characterized by weights along predetermined directions and by depth of the image area related to this feature (e.g., by depth of a pixel or a group of pixels). For example, for an image of a dark grill of a window with light sky background, for usual frame orientation, the weights of the border between an edge of a vertical rod of the grill and the surrounding air shall have maximum values for vertical direction, not very large values for slant directions of +45° and −45° relative the horizon line and minimum values for horizontal direction. The weight and depth values of the image visual features may form a data array of a corresponding dimension to make processing the data more convenient.

The low polygonal grid is a grid containing comparatively low number of cells. It should be clear that it makes sense to use an orthogonal grid in orthogonal coordinate system, which grid form squares; however, this is not the only implementation option of the low polygonal grid for this invention. Each cell of the low polygonal grid relates to an area of the initial 3D scene image, so the corresponding area of the initial 3D scene image is deformed when a node of the low polygonal grid shifts (i.e., during deformation of the low polygonal grid).

The depth data of the initial 3D scene image may be normalized prior to Step (2) to speed up calculations. Size of the initial 3D scene image may be decreased prior to Step (2) to reduce effect of noise of the initial image on the further processing the image according to the algorithm. MIP mapping may be used for reducing size of the initial 3D scene image. The color data and the depth data may be averaged and/or filtered when reducing size of the initial 3D scene image.

An optimal size of the low polygonal grid may be determined prior to Step (3). The size of array of the weight and depth values for each visual feature may be reduced to the low polygonal grid size prior to Step (4). The weights of each visual feature may be averaged and the depth of each visual feature may be filtered during reducing size of the weight and depth values array. The averaging and the filtration for each element of the weight and depth values array may be performed, based on adjacent elements of the data array.

The visual features may be determined along plural directions including vertical and horizontal directions and at least two slant directions. For example, they may be two slant directions of +45° and −45° relative to the horizon line as mentioned in the above, or four slant directions of +30°, +60°, −30° and −60° relative to the horizon line.

The visual features may be determined using mathematical techniques that are typically employed for such purpose, e.g., by convolution operation. Alternatively, the visual features may be determined using a neural network trained with specific image examples.

Optimal displacement of the low polygonal grid nodes may be determined using mathematical techniques that are usually employed for such purposes, e.g., by a method of least squares. Alternatively, the displacement of the low polygonal grid nodes may be determined using a neural network trained with specific image examples.

In one embodiment of the invention, a motion vector of each pixel of the initial 3D scene image is additionally received in Step (1), the vector including direction and velocity of the motion. For example, this vector may be generated by the 3D engine and may be transmitted along with the color data and the depth data of the image. Use of the motion vector allows improving accuracy of the reprojection for dynamic items in the 3D scene. In this case, prior to Step (4), motion parameters are determined for each element of the weight and depth values array, based on the motion vector, for each direction of each visual feature of the image, the feature being relevant to the element. Further, in Step (4), reprojection of the 3D scene image is performed, taking into account these motion parameters. The motion parameters may include values of velocity, acceleration (the first derivative of velocity), rotation about at least one axis and size adjustment (e.g., by deformation or scaling) when needed.

The invention also implements a method of providing a required frame rate for 3D scene image in an image presentation device, including the following steps:

(1) receiving a frame of an initial 3D scene image from an image generation device;

(2) processing the initial 3D scene image according to any of the options described in the above;

(3) presenting a frame of reprojected 3D scene image to a viewer prior to receiving a frame of a next 3D scene image from the image generation device.

The image presentation device may be any device that provides displaying the image on a two-dimensional screen. The screen may be flat, convex or concave. Examples of such a device may be displays, TV sets, monitors, plasma panels, projection systems, etc. In an illustrative implementation of the invention, the image presentation device is a head-mounted display or augmented reality glasses.

The image generation device may be any device that provides generation or storage of a sequence of 3D scene images, e.g., a 3D engine, a 3D camera (in particular, like INTEL RealSense), a computer memory device, a Blue Ray disk, etc.

Reprojection of the 3D scene may be performed taking into account tracking data of a viewer, which may represent predicted data regarding position and orientation of the viewer's head at a predetermined point of time in the future. The predetermined point of time in the future may be as close as possible to the moment of presentation of the initial or reprojected 3D scene image to the viewer (i.e., within a time duration of a single frame), while a predetermined frame output rate is maintained. A frame output rate of about 90 fps is considered acceptable in modern VR/AR systems.

Each frame of the initial 3D scene image may be presented to the viewer with no inspection of the viewer tracking data age, whereas a frame of the reprojected 3D scene image may be presented only in cases when a rate of generation of the initial 3D scene images by the 3D engine in not sufficient for maintaining the predetermined frame output rate.

Alternatively, a frame of the initial 3D scene image or a frame of the reprojected 3D scene image may be presented to the viewer, depending on which of them corresponds to more recent viewer tracking data, while a predetermined frame output rate is maintained.

Generation of the reprojected 3D scene image may be delayed to use the most recent viewer tracking data and to generate a reprojected frame as close as possible to the moment of presentation thereof to the viewer with maintaining the predetermined frame output rate. This allows additionally reducing distortion of the reprojected image at the 3D scene item borders.

Reprojection may be performed for images for left and right eyes of the viewer synchronously or asynchronously. Selection of the synchronous or asynchronous mode may be up to the viewer, who may determine their preferences by trial. Alternatively, the synchronous or asynchronous mode may be selected depending on configuration of the image presentation device, including automatic selection.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an implementation example for a method of 6ATSW reprojection according to the invention.

FIG. 2 shows an algorithm flowchart for a method of 6ATSW reprojection according to the invention.

FIG. 3 illustrates relation between size of map RGBA1 (1024×1024 pixels) and size of map RGBA4 (32×32 pixels, where each pixel corresponds to an area of 32×32 pixels in the image).

FIG. 4 shows design of a pixel of map RGBA3 according to the invention.

FIG. 5 illustrates approach to averaging for providing coherence of transformation according to the invention.

FIG. 6 shows one option for interaction of data processing flows during rendering and reprojection according to the invention.

FIG. 7 shows another option for interaction of data processing flows during rendering and reprojection according to the invention.

FIG. 8 shows one more option for interaction of data processing flows during rendering and reprojection according to the invention.

FIG. 9 shows frames with a low polygonal grid superimposed thereon, namely, initial image (left) and reprojected image (right).

FIG. 10 shows an enlarged portion of reprojected image of FIG. 9, where the image is additionally geometrically pre-distorted.

FIG. 11 shows simplified (schematic) pictures of frame portions for initial image (left) and reprojected image (right), both corresponding to the image of FIG. 10.

FIG. 12 shows superimposed grids of images of FIG. 11 (before and after reprojection) as illustration of shift of grid nodes and displacement of specific visual features of the image as resulted from 6ATSW algorithm according to the invention.

### DETAILED DESCRIPTION OF EMBODIMENTS OF THE INVENTION

Reference will now be made in detail to the preferred embodiments of the present invention, examples of which are illustrated in the accompanying drawings.

Description of an illustrative example of the invention implementation related mainly to virtual or augmented reality systems for entertainment, information, education, scientific, industrial, etc. purposes is provided below. These systems are the most likely to be implemented; however, they are not exclusive application options for the method according to the invention. The approach for processing 3D scene image aimed at decreasing distortion of the image at item borders during reprojection, increasing frame rate and/or reducing data amount in image transfer channel may be used in any other systems related to generating and presenting 3D scene images with shift of view (point of view). Examples of such systems may include CAD/CAM systems, scientific systems for spatial modelling (in particular, for organic synthesis and biotechnologies), graphical systems of simulators for car drivers, ship drivers, pilots, operators of construction machinery, operators of handling equipment, etc. These systems do not necessarily represent virtual or augmented reality systems, i.e., they may have different level of immersiveness and different immersive mechanisms.

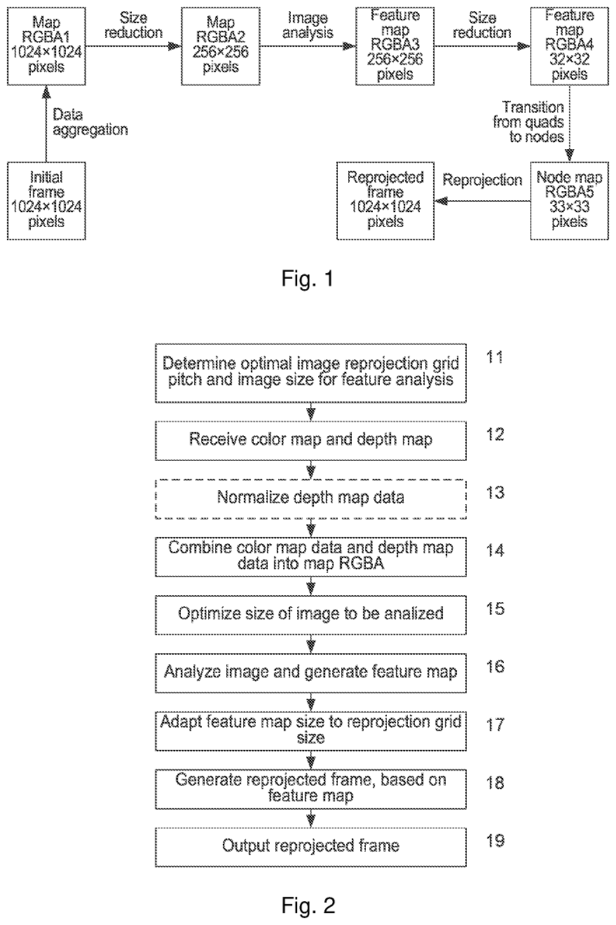

FIG. 1 shows an illustrative example of implementation of the 6ATSW reprojection method, wherein an initial frame (having image size of 1024×1024 pixels in this case) is transformed into a composite map labelled as RGBA1 (also having image size of 1024×1024 pixels) by aggregation of the color data and the depth data. The composite map size is further decreased (to size of 256×256 pixels in this case) to obtain an intermediate map labelled as RGBA2. Further, image of map RGBA2 is analyzed to detect specific visual features (hereinafter referred to as simply features for short) and obtain a feature map labelled as RGBA3. Size of map RGBA3 is further decreased (e.g., to size of 32×32 pixels) to obtain a feature map labelled as RGBA4 that is further transformed into a node map labelled as RGBA5 (having size of 33×33 pixels) also referred to as a transformation map. Transformation of the initial frame image (i.e., reprojection thereof) is performed based on map RGBA5 to obtain a reprojected frame (having image size of 1024×1024 pixels). It shall be clear to a skilled person that the above-indicated numerical values are selected entirely for illustrative purpose to facilitate better understanding the gist of the invention and, as a matter of actual practice, they may be different.

FIG. 2 shows an algorithm flowchart for the 6ATSW reprojection method.

In step 11, an optimal grid pitch, which is further used for image reprojection, and optimal resolution of image to be analyzed for detecting specific visual features are determined. Parameters of VR/AR system like display resolution, lens distortion in VR/AR headset, etc. are taken into account when determining the grid pitch.

The reprojection task to be accomplished by the 6ATSW algorithm implies use of as fast method of generation of image for intermediate frame as possible, while requirement regarding quality of the generated image is met. One of the fastest methods is projecting the image onto a low polygonal grid and further shifting nodes of this grid depending on the user's motion. Optimal grid pitch has a trade-off value, since decreasing the grid pitch improves quality of image (reduces artifacts), but also increases the computational load of the VR/AR system, while increasing the grid pitch deteriorates quality of image, since more items with different depths in the 3D scene are located in each cell of the grid. Generally, the grid pitch may be selected by the user depending on their personal preferences, or determined by the VR/AR system, based on comparison of the system performance and complexity of 3D scenes.

For example, when horizontal resolution of a frame generated by a 3D engine is 1024 pixels, and the user would like to use a grid with horizontal cell size of 40 pixels, then optimal grid pitch may be determined among values 1024, 512, 256, 128, 64, 32, 16, etc. The value of 32 pixels from this series is the closest to 40 pixels. The vertical grid pitch is determined, based on form factor (i.e., relation between side sizes) of the initial frame. The grid mostly has square cells, but the grid may have non-square cells in some implementations of the invention. For example, the cell may be represented by a rectangle with side sizes relation of 1:1.5, 3:4, etc. When a non-orthogonal coordinate system is used, the grid may have non-rectangular cells. In this example, the grid is a low polygonal grid because it is 32×32, which is much coarser than the original 1024×1024.

Analysis of an image of a smaller size than the size of the initial image of map RGBA1 is preferable. This allows avoiding or reducing effect on reprojection caused by small and non-essential elements of image as well as noise and defects at item borders. In addition, this streamlines processing and decreases use of computing resources of the VR/AR system. Use of n-fold reduction of the initial image size is preferable. In other implementations of the invention, this size reduction may be plain (non-folded) and may be performed by any suitable technique known to skilled persons in the art.

In some implementations of the invention, the image analysis may be done regarding map RGBA1 of the same size as the initial image. This may be acceptable for VR/AR systems with displays of comparatively low resolution.

Generally, size of image to be analyzed shall be greater than the pitch of low polygonal grid used for generation of reprojected frames (i.e., the analysis should be performed for image of greater resolution than the reprojection grid pitch). Relation between the size of image to be analyzed and the grid pitch may be n-folded. FIG. 1 shows an example, where the size of image to be analyzed is 8 times greater than the low polygonal grid size.

Selection of the size of image to be analyzed in step 11 may be done taking into account MIP mapping performed by graphical subsystem of the VR/AR system. MIP mapping approach is well known to skilled persons (e.g., see [6]), therefore, its details are omitted for brevity.

The above-indicated parameters are usually determined once during initialization or setup of the VR/AR system prior to its operation start. However, the algorithm may sometimes include adjusting these parameters during operations of the VR/AR system, e.g., manually by the user at their discretion or automatically when nature of 3D scenes changes.

Input data of the algorithm is received in step 12 for processing, namely, color map and depth map both generated by 3D engine of the VR/AR system.

Normalizing the depth map is performed in step 13. Generally, the depth map is received from the 3D engine using floating point format and further transformed into a format, where each depth pixel is represented by one byte. This allows streamlining data processing and/or reducing computational load of the VR/AR system hardware. However, this step is optional and may be omitted in some implementations of the invention.

Consolidation of data of the color map and the depth map into the composite map RGBA1 is performed in step 14. RGB (red, green, blue) channels of map RGBA1 comprise information of color and brightness, while channel A comprises depth information. The above-mentioned depth map normalization allows implementing map RGBA1 using a standard 32-bit pixel format, where transparency information in channel A is replaced with information of image depth.

Transformation of the initial image to the size determined in step 11 is performed in step 15 to obtain map RGBA2.

Further, the image is analyzed and a feature map RGBA3 is formed in step 16. Details of step 16 are described below.

Size of the feature map RGBA3 is reduced in step 17 to obtain a feature map RGBA4 with size corresponding to the grid pitch determined in step 11. Map RGBA4 is further used for reprojecting the image.

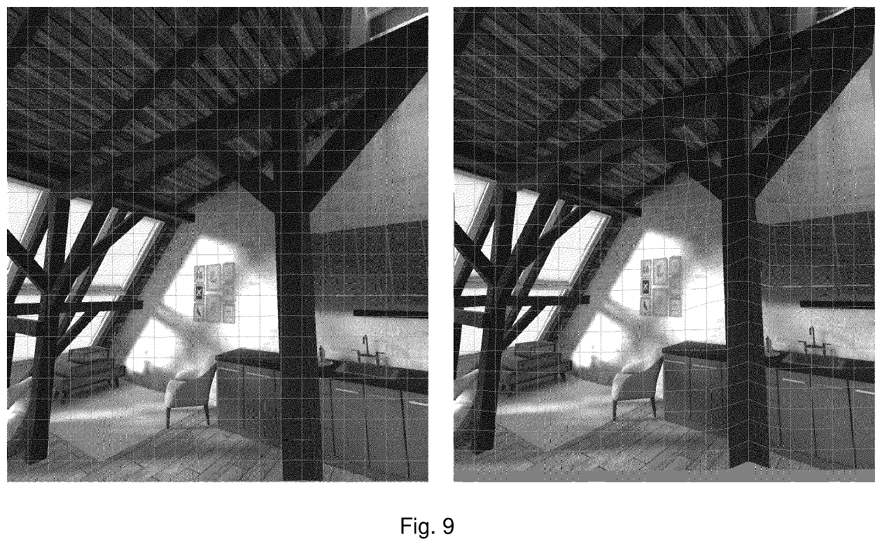

A reprojected frame is generated, based on the feature map in step 18. Details of step 18 are described below with reference to FIGS. 9-12.

The generated frame is outputted to a display for presenting to a viewer in step 19.

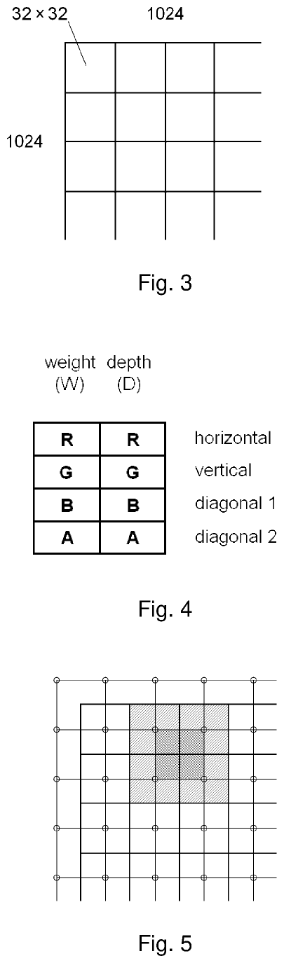

An illustrative example of maps RGBA4 and RGBA5 is shown in FIGS. 3-5. FIG. 3 shows relation between sizes of map RGBA1 (1024×1024 pixels) and map RGBA4 (32×32 pixels) of FIG. 1, where each pixel of map RGBA4 corresponds an area of 32×32 pixels in the initial frame. It shall be clear to a skilled person that size of map RGBA1 may be different in various implementations of the invention, e.g., 1920×1024, 1920×1080, 1920×1200, 1920×1600, 1920×1920 pixels, etc., depending on resolution of the used display and performance of the 3D engine in the VR/AR system, and that the size of 1024×1024 pixels is selected merely for simplicity of disclosure of the illustrative implementation example of the invention.

In the illustrative example of FIG. 3, the initial map RGBA1 was downsampled to obtain an intermediate map RGBA2, where each pixel of map RGBA2 sized to 256×256 pixels contains a certain averaged value of color and depth for an area of 4×4 pixels in the initial map RGBA1. Algorithms of averaging values of color and depth are well known to skilled persons, therefore, their detailed description is omitted for brevity. It is sufficient to mention that such averaging may be simple arithmetical averaging, averaging based on weight factors or non-linear averaging, and that corresponding filters (like Chebyshev filters, Lanczos filters, elliptical filters, etc.) may be used. For example, selection of the averaging technique may depend on extent of averaging (i.e., extent of change in size of the initial map RGBA1), nature of the image, performance of the hardware available for this operation, rate of utilization thereof by other processes, etc.

The feature map RGBA3 was formed, based on map RGBA2. Each pixel of map RGBA3 contains information on behavior of each corresponding area of 4×4 pixels in the initial frame during generation of the reprojected image, i.e., information indicating in which direction and to which extent a corresponding node of the reprojection grid shall be shifted. The feature map contains results of image analysis in several directions. Determination of specific visual features in the 3D scene image is based on color of pixels and the depth map and may be performed taking into account gradient of pixel color in RGB channel and maximum value of pixel brightness in channel A of map RGBA2 along each direction.

In one implementation example of the invention, a gradient of pixel color in RGB channel for eight adjacent pixels may be taken into account and image analysis results for several directions may contain a vector sum of gradients. In another implementation example of the invention, the gradient may be taken into account not just for adjacent pixels, but also for more distant pixels, and image analysis results for several directions may contain a vector sum of gradients, where contribution of pixels located at different distances is determined by a weight factor.

In one implementation example of the invention, the maximum value of pixel brightness in channel A may be selected among brightness values of each pixel and eight adjacent pixels.

In one more implementation example of the invention, the image analysis may be done using a trained neural network. Other methods of image analysis may also be applied, e.g., like those described in [7].

The specific visual features in this invention context are conceptually based on Haar-like features [8]. In particular, such features may be physical borders of items in the 3D scene, contrast (by color or brightness) edges of the image areas (e.g., like in “zebra” or “check pattern” textures) and gradients (e.g., like a clear sunset sky gradient).

Various known methods like Sobel, Canny, Prewitt or Roberts techniques, fuzzy logic, etc. may also be used for detection of the features.

In an illustrative implementation example of the invention, the specific visual features of the image are analyzed along four directions, including two main directions (horizontal and vertical) and two additional directions (diagonal 1 and diagonal 2). In other cases, the number of directions may be different. In particular, four additional directions (that may be located at 30° angle pitch to the coordinate frame axes) may be used instead of two additional directions (e.g., diagonals that may be located at 45° angle to the coordinate frame axes). Increase in the number of directions for the feature analysis improves reprojection accuracy, but requires more computational resources, in particular, higher operation speed and larger memory of the VR/AR system hardware. Therefore, selection of the number of directions is a matter of trade-off and it may depend on some parameters of the VR/AR system, in particular, purpose of the system, display capabilities, nature of 3D scenes, etc.

Feature weight (W) and depth (D) are indicated in map RGBA3 for each pixel and each direction. In an illustrative implementation example of the invention, the weight and the depth for four directions are contained in the following channels: R is horizontal border; G is vertical border; B is diagonal 1; A is diagonal 2 (FIG. 4). It should be clear to a skilled person that the number of channels and data distribution therein may be different in other cases.

Thus, each pixel of map RGBA3 contains information of color gradient in channel RGB along each direction to be analyzed and information of brightness in channel A of the corresponding pixel of map RGBA2.

It should also be clear to a skilled person that the number of pixels in map RGBA2 and map RGBA3 may be different in various implementations of the invention. Increase in size of maps RGBA2 and RGBA3 (i.e., a number of pixels therein by vertical and horizontal directions) improves reprojection accuracy, but requires more computational resources, in particular, higher operation speed and larger memory of the VR/AR system hardware. Therefore, selection of size of these maps is a matter of trade-off and it may depend on some parameters of the VR/AR system, in particular, purpose of the system, display capabilities, nature of 3D scenes, etc.

Map RGBA3 is transformed to map RGBA4 (having size determined in step 11) for use in further steps of the 6ATSW algorithm. In an illustrative example according to FIGS. 1 and 3, map RGBA3 was transformed from 256×256 pixels to 32×32 pixels to obtain map RGBA4.

It should be noted that two-step “coarsing” data (the first one when initial map RGBA1 is transformed to map RGBA2 and the second one when map RGBA3 is transformed to map RGBA4) provides better combination of reprojection accuracy and operation speed of the 6ATSW algorithm than one-step “coarsing” data with the same factor during transformation of map RGBA3 to map RGBA4. For example, transformation of the initial map (RGBA1) with size of 1024×1024 pixels to the intermediate map (RGBA2) with size of 256×256 pixels followed by generation of the border map (RGBA3) with size of 256×256 pixels and further transformation thereof to the border map (RGBA4) with size of 32×32 pixels (see FIG. 1) is usually more preferable than transformation of the initial map (RGBA1) with size of 1024×1024 pixels to the border map (RGBA3) with size of 256×256 pixels and further formation the border map (RGBA4) with size of 32×32 pixels therefrom.

When map RGBA3 of 256×256 pixels was reduced to 32×32 pixels to obtain map RGBA4, feature weight values (W) were averaged, based on adjacent pixels (e.g., by four or eight adjacent pixels) and feature depth values (D) were averaged, based on adjacent pixels (e.g., four or eight adjacent pixels) and weighted with feature weights (W) of these pixels.

Like in map RGBA3, each pixel in map RGBA4 contains information of the specific visual features detected in the image and information of weights of these features. Map RGBA4 was transformed into node map RGBA5 to provide transition from this information to data of direction and extent of displacement of a node of low polygonal grid during reprojection.

To do that, a coordinate grid was superimposed onto map RGBA4 so as the coordinate grid nodes (marked with circles in FIG. 5) was placed in centers of pixels in map RGBA4. As may be seen in FIG. 5, the size of this coordinate grid is larger by one for both coordinates than size of map RGBA4. If the size of map RGBA4 is generally equal to N×M, then the size of the second coordinate grid is (N+1)×(M+1). When the coordinate grid is superimposed onto map RGBA4 with the size of 32×32 pixels, as shown in illustrative example in FIG. 3, then the size of this coordinate grid is 33×33 cells.

The coordinate grid of 33×33 cells defines size of the node map (RGBA5) that is referred to as the transformation map and used for generation of reprojected image. Each pixel of the transformation map contains information on displacement of vertex of each corresponding area in the initial frame during generation of the reprojected image.

The value of each pixel of map RGBA5 may be averaged (blurred), based on adjacent pixels of map RGBA4 to provide coherence of transformation. FIG. 5 illustrates concept of such blurring, where a pixel of map RGBA5 (marked with cross-hatching) is averaged, based on four pixels of map RGBA4 (marked with slanted hatching). It should be clear to a skilled person that marginal constraints apply to edges and corners of map RGBA4, so averaging is either performed based on two pixels of map RGBA4 (at edges) or absent as such (in corners) in such a case. Averaging algorithms are well-known to skilled persons, therefore their detailed description is omitted for brevity. It is sufficient to mention that the averaging may be simple arithmetical averaging, averaging based on weight factors or non-linear averaging using corresponding filters (e.g., Chebyshev filters, Lanczos filters, elliptical filters, etc.).

As a result of transformation of the initial frame, the reprojected frame is generated, based on map RGBA5, and outputted to a display for presenting to the viewer. When the reprojected frame is generated, each area of the initial frame image is transformed according to corresponding pixel of map RGBA5 so as each vertex of an area with size of 32×32 pixels of the initial frame is shifted depending on geometrical position of features in the 3D scene in this area, i.e., the area is deformed according to displacement of the viewer's point of view. Shift of vertices of this area causes deformation of image in this area, which is implemented by algorithms that are known to persons skilled in the art. It should be enough to mention that the deformation may be provided, e.g., by affine transformation or other applicable mathematical techniques.

It should be noted that the shift of vertices in this area may also be affected by motion of items in the 3D scene as defined by scenario of actions in the 3D scene and does not depend on displacement of the viewer's point of view. It shall be clear to a skilled person that the algorithm may take into account this motion of items along with displacement of the viewer's point of view to improve quality of reprojection. Motion vector of each pixel of the initial 3D scene image may be used for taking into account this motion, where the motion vector contains direction and motion speed as described in the above.

Reprojection according to this invention is of asynchronous nature. In other words, generation of image for each eye is performed in two flows, the first flow relating to 3D scene rendering and the second flow relating to 3D scene reprojection. If rendering a new original frame is not complete by the time when a new frame shall be outputted to maintain a required frame output rate, then a reprojected frame is outputted, which is the most recent original frame after reprojection applied thereto. The original frame here is a frame generated in the rendering flow, and the reprojected frame is a frame generated in the reprojection flow. Each flow is operated at its own rate caused by parameters of corresponding process like 3D scene complexity, tracking speed, computational resources dedicated to this process, etc. Rates of the flows may be different, both in terms of average and instant values, i.e., the rate may vary and may depend on, e.g., 3D scene complexity.

Depending on the method of outputting image to display for left and right eye of the user, requesting initial frames intended for left and right eye of the user from the 3D engine, conveying thereof to reprojection and outputting the reprojected frames to a screen may be performed in different order. When the VR/AR system employs simultaneous output of frames for left and right eyes of the user, e.g., if a single display with left and right portions thereof dedicated, correspondingly, for left and right eye of the user is used and the image is outputted to the screen by lines (using horizontal scan line), then reprojection is performed simultaneously for left and right eyes.

When the VR/AR system employs alternate output of frames for left and right eyes of the user, e.g., if a separate display is used for each eye or if a single display is used, but images in its left and right portions are outputted consequently by columns (using vertical scan line), then reprojection of frames for left and right eyes may be performed independently. In this case, the most recent frame generated by the 3D engine for the corresponding eye is used as a base for reprojection, i.e., when frame reprojection is performed for left eye, the 3D engine is able to generate a new original frame for right eye, which shall be used directly or as a base for reprojection for right eye. In this case, the reprojected frames of 3D scene relate to different moments of time.

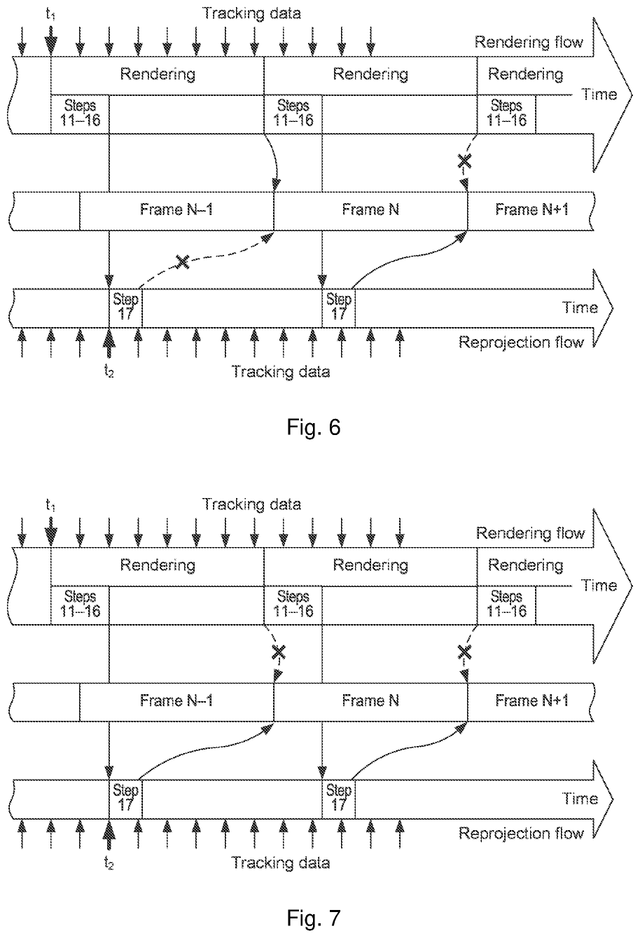

FIGS. 6 and 7 illustrate two implementation options for the invention, where steps 11-16 of the reprojection algorithm (FIG. 2) are performed in the rendering flow, and step 17 is performed in the reprojection flow. Duration of each action is shown arbitrarily (no time scale is maintained); however, it shall be clear to a skilled person that the reprojection duration is substantially less than the rendering duration in most cases.

In one implementation example of the invention, each original frame generated in the rendering flow may be displayed unconditionally, i.e., with no inspection of relevance of tracking data used for generation of this frame. In particular, in FIG. 6, an original frame generated based on older tracking data (received at time moment t₁) is outputted as frame N, instead of a reprojected frame generated based on the previous original frame, but taking into account more recent tracking data (received at time moment t₂).

In another implementation example of the invention, either an original frame or a reprojected frame may be displayed, depending on which of them was generated using more recent tracking data. In particular, in example of FIG. 7, a reprojected frame generated based on the previous original frame, but taking into account more recent tracking data (received at time moment t₂) is outputted as frame N, instead of an original frame generated based on older tracking data (received at time moment t₁).

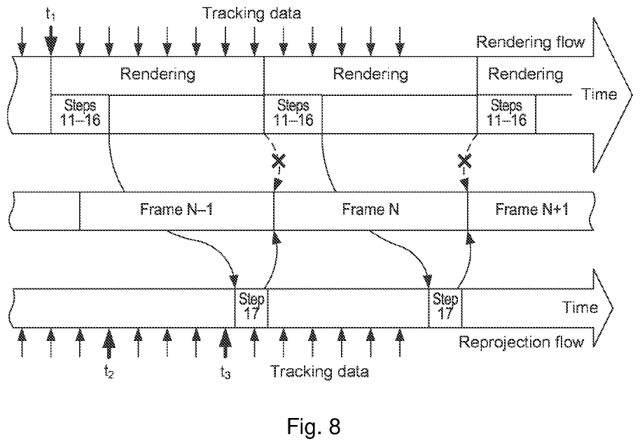

In still another implementation example of the invention, the portion of reprojection algorithm that uses tracking data may be intentionally delayed so as to generate a reprojected frame as close to the displaying moment as possible. This allows performing reprojection using the most recent tracking data and thus improving quality of the reprojected image. In particular, in example of FIG. 8, step 17 is performed with a delay that allows using tracking data received at time moment t₃ instead of tracking data received at time moment t₂. This approach to reprojection also referred to as ALAP (as last as possible) reprojection may be implemented similar to ALAP rendering as described in co-owned earlier application PCT/RU2014/001019 or US Publication 20170366805.

It should be noted that in all of examples in FIGS. 6-8, a reprojected frame is outputted as frame N+1, since a “fresh” original frame is not generated yet by the moment of start of displaying the frame N+1.

Reprojection is performed, based on viewer tracking data, in particular, data of position and orientation of the viewer's head. To assure minimum delay of the VR/AR system response to the viewer's head motion, reprojection may be performed, based on predicted data of position and orientation of the viewer's head at a predetermined time point in the future. This prediction may be done by extrapolation of current tracking data for the viewer, also taking into account historical tracking data. Details of implementation such a prediction are described in co-owned earlier application PCT/IB2017/058068 and all content thereof is included herein by reference.

It should be noted that 3D scene rendering is also performed based on the viewer tracking data and it may also be based on predicted data of position and orientation of the viewer's head at a predetermined time point in the future. If so, the prediction horizons of the rendering flow and the reprojection flow may be the same or different. In particular, since reprojection of 3D scene is usually a faster process than rendering entire 3D scene, the prediction horizon of the reprojection flow may be closer than the prediction horizon of the rendering flow. This allows improving accuracy of prediction of the viewer's position and, therefore, accuracy of reprojection.

It should also be noted that asynchronous reprojection may be performed independently regarding images for left and right eyes of the viewer. Alternatively, asynchronous reprojection may be synchronized regarding images for left and right eyes, still remaining asynchronous for corresponding rendering flows for left and right eyes of the viewer. This kind of synchronization of images for left and right eyes may apply, e.g., during synchronous output of left and right frames caused by display configuration as mentioned in the above. Preferable mode of such synchronization may be defined algorithmically or determined by trial, e.g., according to personal preferences of users of the VR/AR system.

Operations of the 6ATSW reprojection algorithm is further illustrated in FIGS. 9-12.

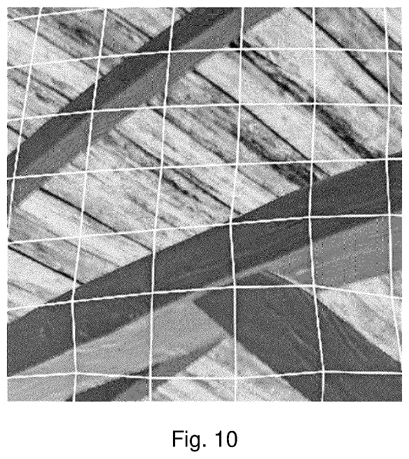

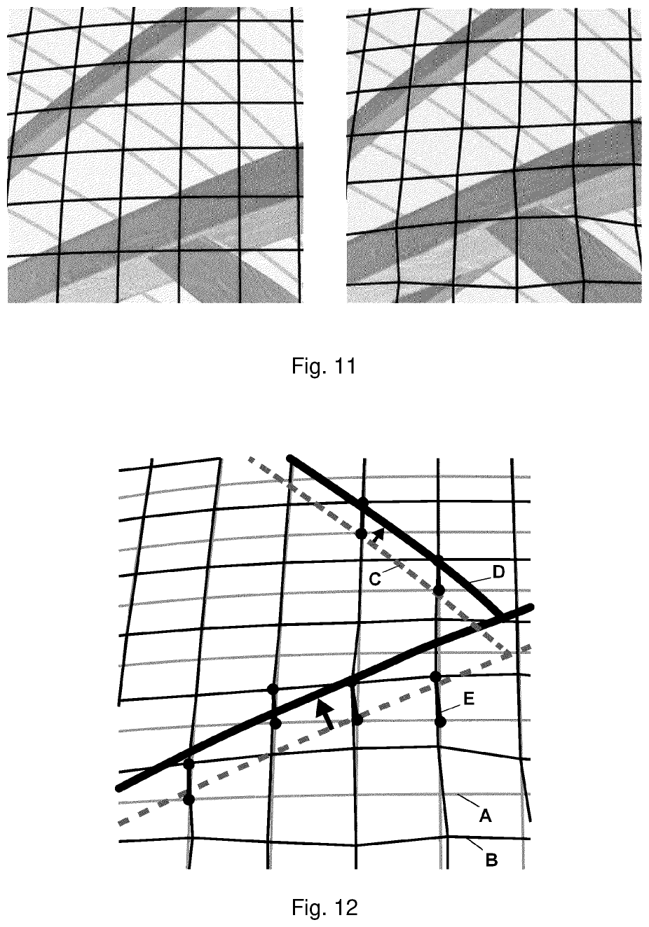

FIG. 9 shows frames containing 3D scene images with superimposed low polygonal grid, namely, an initial image (left) and a reprojected image (right). The frames were rotated and placed in a row for better visual clarity. FIG. 10 shows an enlarged view of a portion of the frame of the reprojected image of FIG. 9. It should be noted that the image of FIG. 10 was additionally geometrically pre-distorted to compensate distortions caused by optical parameters of the head-mounted display lens. In this case, strictly vertical change in position of the user's head with no rotation thereof is illustrated for better clarity. FIG. 11 shows simplified (schematic) pictures of frame portions for the initial image (left) and the reprojected image (right), both corresponding to FIG. 10. Comparison of images in FIG. 11 allows clearly seeing the grid deformation (i.e., displacement of its nodes) and corresponding change in the image related to the grid.

FIG. 12 shows superimposition of reprojection grids for the left and right images of FIG. 11 (before and after reprojection) for illustration of displacement of the grid nodes and specific visual features of the image due to operation of the 6ATSW algorithm according to the invention. Grey color (A) indicates location of the reprojection grid before displacement of its nodes (i.e., corresponding to the left image of FIG. 11), while black color (B) indicates location of the reprojection grid after displacement of its nodes (i.e., corresponding to the right image of FIG. 11). Displacement of the nodes is depicted by straight lines with circles at their ends (E). Displacement of the features is illustrated by example of locations of features corresponding to roof grillage (above) and beam (below), where grey color (C) indicates location of these features before displacement of the reprojection grid nodes, while black color (D) indicates location thereof after displacement of the nodes. Arrows indicate directions of the feature displacement.

Use of feature weights for predetermined directions during reprojection allows providing displacement of the reprojection grid nodes in a certain direction and at a certain distance so as to minimize reprojection artifacts at the feature borders (in particular, at borders of items located at different distances in the 3D scene). For example, displacement along a contrast border in a “zebra”-like texture does not cause noticeable artifacts, therefore, weight factor of such feature in this direction shall be close to zero, which allows shifting the reprojection grid node mainly in other direction, in particular, in order to avoid causing artifacts at the border with another texture (with another specific direction) or with a gradient area in the image. This provides consistence of perceiving the 3D scene by the viewer, still maintaining a required frame rate.

Thus, this invention provides reprojection with a sufficient speed to maintain frame output rate in a VR/AR system, e.g., not less than 90 fps, still assuring enough quality of generation of intermediate frames to preserve presence effect and avoid discomfort in most of users.

It should be noted that frame size after rendering may be somewhat larger than size of the frame actually displayed to the user in some implementations of the invention. This may relate to a desirable “margin” of the image size that is nice to have to provide correct pre-distortion required for various head-mounted displays with different optical properties. In some implementations of the invention, this “margin” may be used for reprojection according to this invention. However, this “margin” cannot be sufficient as it causes overhead load of computational resources and increases shortage thereof, whereas overcoming this shortage is the purpose of this invention.

It should also be noted that the above description contains only actions that are most important for resolving the problem of the invention. It should be clear to a skilled person that other actions are required to provide operations of the VR/AR system like connecting equipment, initialization thereof, launching a corresponding software, transmitting and receiving instructions and acknowledgements, exchanging service data, synchronizing, etc., which detailed description is omitted for brevity.

It should also be noted that the above-specified method may be implemented using software and hardware. Equipment and algorithms for providing tracking the viewer are described in co-owned earlier applications PCT/IB2017/058068 and PCT/RU2014/001019 and all content thereof is incorporated herein by reference. Reprojection algorithms according to this invention may be performed by software means, hardware means or a combination of software and hardware means. In particular, the equipment for execution of the above-specified method may be general purpose computing means or dedicated computing means including a central processing unit (CPU), a digital signal processor (DSP), a field-programmed gate array (FPGA), an application-specific integrated circuit (ASIC), etc.

Data processing in the above-specified method may be localized in one computing means or it may be performed in a distributed manner in plural computing means. For example, the rendering flow in FIGS. 6-8 may be performed in one computing means, while the reprojection flow may be performed in another computing means. It shall be clear to a skilled person, that this example is not limiting and distribution of computational load over hardware devices may be provided in different manner within the gist of this invention.

The devices and their parts, methods and their steps mentioned in the description and shown in the drawings relate to one or more particular embodiments of the invention, when they are mentioned with reference to a numeral designator, or they relate to all applicable embodiments of the invention, when they are mentioned without reference to a numeral designator.

The devices and their parts mentioned in the description, drawings and claims constitute combined hardware/software means, where hardware of some devices may be different, or may coincide partially or fully with hardware of other devices, if otherwise is not explicitly stated. The hardware of some devices may be located in different portions of other devices, if otherwise is not explicitly stated. The software content may be implemented in a form of a computer code contained in a storage device.

The sequence of steps in the method description provided herein is merely illustrative and it may be different in some embodiments of the invention, as long as the function is maintained and the result is attained.

Features of the invention may be combined in different embodiments of the invention, if they do not contradict to each other. The embodiments of the invention discussed in the above are provided as illustrations only and they are not intended to limit the invention, which is defined in claims. All and any reasonable modifications, alterations and equivalent replacements in design, configuration and mode of operation within the invention gist are included into the scope of the invention.

It should also be noted that the above description of the implementation examples relates to use of the method in virtual or augmented reality systems for entertainment purpose, first of all, in computer games. However, this method is fully applicable in any other area for solving problems of adaptive generation of intermediate frames, based on image analysis and detection of borders of items located at different distances.

In particular, the above-discussed method may be advantageously employed for generation of images in 3D rendering systems for educational, scientific or industrial purpose (e.g., in simulators intended for astronauts, aircraft pilots, operators of unmanned vehicles, ship drivers, operators of cranes, diggers, tunneling shields, miners, etc.), including those currently existing and possibly upcoming in the future.

Having thus described a preferred embodiment, it should be apparent to those skilled in the art that certain advantages of the described method and system have been achieved.

It should also be appreciated that various modifications, adaptations, and alternative embodiments thereof may be made within the scope and spirit of the present invention. The invention is further defined by the following claims.

### NON-PATENT LITERATURE (INCORPORATED HEREIN BY REFERENCE IN THEIR ENTIRETY)

1. Artyom Klinovitsky. Auto-optimization of virtual reality or about difference between reprojection, timewarp and spacewarp. Habr: Pixonic, 24.08.2017 habr.com/company/pixonic/blog/336140
2. Timewarp. XinReality, Virtual Reality and Augmented Reality Wild xinreality.com/wiki/Timewarp/
3. Michael Antonov. Asynchronous Timewarp Examined. Oculus developer blog, 02.03.2015 developer.oculus.com/blog/asynchronous-timewarp-examined/
4. Asynchronous Spacewarp. XinReality, Virtual Reality and Augmented Reality Wild xinreality.com/wiki/Asynchronous_Spacewarp/
5. Dean Beeler, Ed Hutchins, Paul Pedriana. Asynchronous Spacewarp. Oculus developer blog, 10.11.2016 developer.oculus.com/blog/asynchronous-spacewarp/
6. Mipmap. Wikipedia, the free encyclopedia en.wikipedia.org/wiki/Mipmap/
7. Brian A. Barsky, Michael J. Tobias, Daniel R. Horn, Derrick P. Chu. Investigating occlusion and discretization problems in image space blurring techniques. Proceedings of Conference: Vision, Video, and Graphics, VVG 2003, University of Bath, UK, Jul. 10-11, 2003
8. Haar-like feature. Wikipedia, the free encyclopedia en.wikipedia.org/wiki/Haar-like_feature/

1. A method of processing a 3D scene image comprising the steps of:
(1) receiving color data and depth data of an initial 3D scene image for view A;
(2) determining visual features of the initial 3D scene image and weights of the visual features, based on the color data, and determining depths of the visual features of the 3D scene image based on the depth data;
(3) generating a low polygonal grid superimposed onto the initial 3D scene image for reprojection;
(4) reprojecting the initial 3D scene image for view B different from view A by displacing nodes of the low polygonal grid depending on the weights and depths of the image visual features.

2. The method of claim 1, wherein, prior to step (2), size of the 3D scene image is decreased to reduce effect of image noise.

3. The method of claim 2, wherein MIP mapping is used for decreasing size of the 3D scene image.

4. The method of claim 2, wherein color data and depth data are averaged and/or filtered for decreasing size of the 3D scene image.

5. The method of claim 1, wherein each cell of the low polygonal grid is aligned with an area of the initial 3D scene image.

6. The method of claim 1, wherein, prior to step (3), an optimal size of the low polygonal grid is determined based on size of the initial 3D scene image and complexity of the 3D scene.

7. The method of claim 1, wherein, prior to step (4), size of an array of the weight and depth values for each visual feature is reduced to the low polygonal grid size.

8. The method of claim 7, wherein the weight values of each visual feature are averaged and the depth value of each visual feature is filtered during reducing size of the weight and depth values array.

9. The method of claim 8, wherein the averaging and filtering for each element of the weight and depth values array are performed, based on adjacent elements of the element.

10. The method of claim 1, wherein the image visual features are determined along multiple directions.

11. The method of claim 10, wherein the multiple directions of the image visual features include vertical direction and horizontal direction.

12. The method of claim 11, wherein the multiple directions of the image visual features include at least two slant directions.

13. The method of claim 1, wherein the image visual features are determined using convolution operation.

14. The method of claim 1, wherein the image visual features are determined using a neural network.

15. The method of claim 1, wherein the displacement of the low polygonal grid nodes is determined by a method of least squares.

16. The method of claim 1, wherein displacement of the low polygonal grid nodes is determined using a neural network.

17. The method of claim 1, wherein, prior to step (2), the depth data of the initial 3D scene image is normalized.

18. The method of claim 1, wherein step (1) further includes receiving a vector of motion for each pixel of the initial 3D scene image, the vector including direction and velocity of the motion.

19. The method of claim 18, wherein, prior to step (4), parameters of the motion are determined along directions of the visual features, based on the motion vector, for each element of the weight and depth values array.

20. The method of claim 19, wherein, in step (4), the 3D scene image is reprojected taking into account the motion parameters.

21. A method of providing a required frame rate for 3D scene image in an image presentation device, comprising the steps of:
(1) receiving a frame of an initial 3D scene image from an image generation device;
(2) reprojecting the initial 3D scene image by displacing nodes of a low polygonal grid superimposed onto the initial 3D scene image, depending on weights and depths of visual features of the initial 3D scene image, where the weights are determined based on color data of the initial 3D scene image, and the depths are determined based on depth data of the initial 3D scene image;
(3) presenting a frame of the reprojected 3D scene image to a viewer prior to receiving a frame of a next initial 3D scene image from the image generation device.

22. The method of claim 21, wherein the 3D scene image is reprojected taking into account tracking data of the viewer.

23. The method of claim 22, wherein the viewer tracking data is predicted data of position and orientation of the viewer's head at a predetermined point of time in the future.

24. The method of claim 23, wherein the predetermined point of time in the future is selected close to a moment of presentation of the initial or reprojected 3D scene image to the viewer, while a predetermined frame output rate is maintained.

25. The method of claim 22, wherein each frame of the initial 3D scene image is presented to the viewer with no inspection of age of the viewer tracking data, and a frame of the reprojected 3D scene image is presented to the viewer only when a rate of generation of the initial 3D scene images by the 3D engine in not sufficient for maintaining a predetermined frame output rate.

26. The method of claim 22, wherein either a frame of the initial 3D scene image or a frame of the reprojected 3D scene image is presented to the viewer, depending on which of them corresponds to more recent viewer tracking data, while a predetermined frame output rate is maintained.

27. The method of claim 22, wherein generation of the reprojected 3D scene image is delayed so as to use the most recent viewer tracking data and to generate a reprojected frame close to a moment of presentation thereof to the viewer, while a predetermined frame output rate is maintained.

28. The method of claim 21, wherein steps (1)-(3) are performed simultaneously for images intended for left eye and for right eye of the viewer.

29. The method of claim 21, wherein steps (1)-(3) are performed non-simultaneously for images intended for left eye and for right eye of the viewer.

30. The method of claim 21, wherein steps (1)-(3) are performed non-simultaneously or simultaneously for images intended for left eye and for right eye of the viewer based on the viewer's selection.

31. The method of claim 28, wherein a horizontal scan line is used in the image presentation device.

32. The method of claim 29, wherein a vertical scan line is used in the image presentation device or separate displays are used for left and right eye of the viewer.
